(19) United States
(12) Patent Application Publication
(10) Pub. No.: US 2015/0193167 A1
(43) Pub. Date: Jul. 9, 2015

(54) THREE-IN-ONE PORTABLE STORAGE DEVICE

(71) Applicant: Imation Corp., Oakdale, MN (US)

(72) Inventors: Toshihide Hokari, Woodbury, MN (US); Alan Olson, Cottage Grove, MN (US); Blake A. Verdon, St. Paul, MN (US)

(21) Appl. No.: 14/589,120

(22) Filed: Jan. 5, 2015

Related U.S. Application Data
(60) Provisional application No. 61/923,920, filed on Jan. 6, 2014.

(51) Int. Cl. G06F 3/06

(52) U.S. Cl. CPC G06F 3/0626; G06F 3/0679; G06F 3/0655

(57) ABSTRACT

Aspects of the invention generally relate to a portable storage device having a memory and a plurality of connectors. The portable storage device can include a first connector for connecting to a first remote device, such as a smartphone or tablet. The portable storage device can receive digital data from the remote device, or can transfer digital data to the remote device. The portable storage device can include a second connector for connecting to an external device, such as a computer. Similarly, the second connector can enable the two-way transfer of digital data between the external device and the portable storage device. The portable storage device can include a third connector for connecting to a second remote device to enable the two-way transfer of digital data between the portable storage device and the second remote device. The portable storage device can facilitate data transfer between remote and external devices.

### RELATED APPLICATIONS

The present application claims priority to U.S. provisional application No. 61/923,920, the entire contents of which are incorporated herein by reference.

### BACKGROUND

Remote devices with multiple functionalities are becoming increasingly popular. For example, a smartphone will often serve not only as a user's cellular phone, but also as the user's photo and video camera and music and video player, in addition to an ever-increasing number of other functions. As the functionality of such devices grow, the demand on the battery life and memory storage capacity increases. When a battery dies, a user is forced to find a power source such as a wall receptacle or a computer via which to recharge the battery for further use. In addition, when the memory of the remote device becomes full, a user must unload digital data from the memory so that he or she can continue to utilize the remote device as intended, for example by capturing images or videos. In addition, many remote devices have specific and varying connection ports for interfacing with the device. As such, a user must have the appropriate connector with them in addition to means for recharging the battery and/or transmitting/receiving digital data from the remote device.

The sharing of digital data between remote devices is also a popular feature. However, because devices are configured differently and require varying connectors for interfacing, sharing typically must be performed by first moving digital data off of one device onto, for example, a computer, and then uploading the digital data to the second device. This is inconvenient as often users do not readily have access to such a device when desiring to share data. Often, differing devices require different connectors for interfacing, and a single link between the two is difficult or impossible to find. Moreover, many devices comprise operating systems and file structures that may be incompatible with one another even if such a single link for interfacing the two existed. One alternative is to use wireless data transfer, such as Bluetooth, cellular data, or WiFi. However, such alternatives can be slow, expensive, and/or at times completely unavailable for a user.

### SUMMARY

Aspects of the present invention provide a portable storage device having a memory and three or more connectors. The portable storage device comprises a first connector for connecting to a first remote device. The first connector can be a dedicated connector for a particular remote device. In some examples, the memory of portable storage is in two-way communication with the first remote device via the first connector, allowing for the transfer of digital data between the two devices.

The portable storage device can include a second connector for connecting to an external device such as a computer. The second connector can allow two-way data transfer between the memory of the portable storage device and an external device. This allows a user to unload digital data from the memory of the portable storage device, freeing the memory for further use.

The portable storage device can further include a third connector for connecting to a second remote device. The third connector can provide two-way data transfer between the memory of the portable storage device and the second remote device. Accordingly, a user can transfer data from a first remote device to the memory of the portable storage device via the first connector, and then to the second remote device via the third connector. Thus, the user is provided a way for effectively and portably transferring data between the first and second remote devices as the portable storage device acts as an intermediary between the first and second remote devices. In various embodiments, a user can initiate data transfer between the two remote devices from either the first or second remote device.

### BRIEF DESCRIPTION OF THE DRAWINGS

FIG. 1 is a schematic diagram of a portable storage device.

FIG. 2 is a process-flow diagram illustrating an exemplary method for utilizing a portable storage device as an intermediary between two remote devices.

FIG. 3 is a view of an exemplary portable storage device according to some embodiments of the invention.

FIG. 4 is a schematic diagram of a portable storage device including a rechargeable power source.

### DETAILED DESCRIPTION

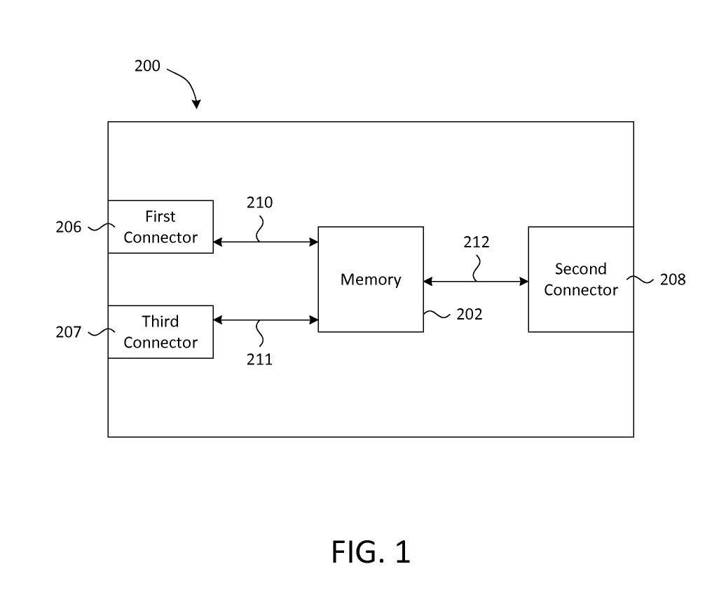

FIG. 1 is a schematic diagram of an exemplary portable storage device according to some embodiments of the invention. Device 200 includes a memory 202, a first connector 206, a second connector 208 and a third connector 207. In some embodiments, the first connector 206 comprises a particularly configured connector configured to connect with a particular remote device or family of remote devices. In general, a remote device is a device that stands alone from a traditional central or local computer and can be used to acquire and/or display or otherwise present digital data such as photographs, video and audio to a user. Such remote devices can include, for example, cellular telephones, smartphones, tablets, cameras, displays, music players and the like. Exemplary connectors an include USB, micro-USB, mini-USB, HDMI, MHL, Lightning, 30-pin, serial connectors and any other connectors known in the art. In various embodiments, connectors can be specific or proprietary to a remote device, or can be more generic. In many cases, remote devices comprise a female port for receiving a connector, and accordingly, in some embodiments, the first connector 206 comprises a corresponding male connector for connecting to the remote device. In some embodiments, the first connector 206 comprises a male connector at the end of a cable secured to the body of the portable storage device to facilitate coupling of the first connector and the remote device.

First connector 206 can be communication with memory 202 via two-way communication 220. Two-way communication 220 can be used to send/write data from the remote device to memory 202 or to retrieve/read data from memory 202 to the remote device. Memory 202 can include flash technology, hard drive technology, or other storage technologies known in the art. In some embodiments, flash memory is used to minimize the physical size required for the portable storage device 200. Accordingly, some portable storage devices include flash memory 202 in sizes of, for example, 16, 32, 64, 128, 256 or 512 GB, or 1 TB. In some embodiments, portable storage device 200 comprises dedicated, built-in memory 202. Device 200 can alternatively or additionally receive or comprise removable memory 202, such as an SD or microSD card. Removable memory 202 can allow the user to provide an appropriate amount of memory for the portable storage device 200 in accordance with the user's desired capacity and cost. To facilitate removable memory 202, the portable storage device 200 can comprise a slot or receptacle for receiving removable memory 202. A user can insert or remove memory 202 into or from receptacle. Thus, in some embodiments, the memory 202 of the portable storage device 200 is of a variable size, wherein the user can insert memory 202 of any desirable size and can exchange one sized memory for another.

A remote device can be connected to the portable storage device 200 via the first connector 206 and thereby interface with memory 202 via two-way communication 210 to facilitate the transfer of digital data between the portable storage device 200 and the remote device. In some examples, a user can choose to copy digital data from the remote device to the memory 202 of the portable storage device 200 to back up the data, or to move the data from the remote device to memory 202 to clear space on the remote device. Thus, as used herein, transferring data can refer to moving or copying data from one location to another. In addition, the user can choose to upload digital data from the memory 202 of the portable storage device 200 to the remote device, or to stream digital data from memory 202 to the remote device. Thus, two-way communication 220 allows a user to move data back and forth (i.e., read and write data) between a remote device and the memory 202 of the portable storage device 200 by means of the first connector 206.

In some configurations, when connected, the remote device and portable storage device 200 adopt a ‘master/slave’ or a ‘host/device’ relationship. That is, the remote device (master, host) controls the operation of the portable storage device (slave, device). During operation, a user controls two-way data transfer between the remote device and the portable storage device 200 via the remote device. In some configurations, such as in the case of some smartphones or tablets, for example, the user installs an application (app) or other software on the remote device that allows data transfer control operability. In other embodiments, such operability and/or software is available on the remote device by default. In either case, the user initiates the transfer of data in either direction between the two devices.

In some embodiments, the portable storage device 200 comprises a second connector 208 for connecting to an external device. In some embodiments, the second connector 208 comprises a male USB connector, and the external device comprises a computer. The external device can connect to the portable storage device 200 via the second connector 208 and two-way communication via connection 212 enabling read/write operability between the devices. In addition, the user can initiate two-way data transfer between the portable storage device 200 and the external device, enabling the clearing of memory 202 to provide available storage in the portable storage device 200. In some embodiments, the interface between the portable storage device 200 and the external device adopts a similar host/device relationship as described above, in which data transfer is controlled via the external device. The second connector 208 can be secured to the portable storage device via a cable, or can be formed integrally into the body of the portable storage device.

In certain embodiments of the invention, remote device connectable to the first connector 206 comprises a first remote device, and the portable storage device 200 includes a third connector 207, configured to connect to a second remote device. In various embodiments, the third connector 207 can be the same, a similar, or a different connector as the first connector 206. In general, the third connector 207 can therefore likewise be any of USB, micro-USB, mini-USB, HDMI, MHL, Lightning, 30-pin, serial connectors and any other connectors known in the art, for example, without being limited by the type of the first connector 206. Accordingly, the second remote device can be the same as, similar to, or different from the first remote device. In some embodiments, the third connector 207 is a male connector configured to interface with a female receptacle on the second remote device. The third connector 207 can comprise a male connector at the end of a cable secured to the portable storage device 200. In other embodiments, the third connector 206 is integrated into the exterior surface of the portable storage device 200.

The third connector 207 can operate in a similar manner as the first connector 206, providing two-way communication between the second remote device and the memory 202 of the portable storage device 200. In some embodiments, the second remote device can act as a host, controlling the operation of the portable storage device 200. Thus, a user of the second remote device can initiate the transfer of digital data between the second remote device and the memory 202 of the portable storage device 200 through the third connector 207 and connection 211 via the second remote device. In addition, in some embodiments, the second remote device comprises software to facilitate data transfer between the second remote device and memory 202. Software can be included with the device or can be installed by the user, such as the case of an app on a smartphone or tablet, for example.

Embodiments of the portable storage device 200 can receive digital data from or transfer digital data to a first remote device via first connector 206, and similarly receive digital data from or transfer digital data to a second remote device via third connector 207. Accordingly, in some configurations, the portable storage device 200 can act as an intermediary between first and second remote devices. That is, a user or users of first and second remote devices can utilize the portable storage device 200 to transfer digital data between the remote devices even if the first and second remote devices are themselves incompatible for a direct wired transfer of data, whether the operating systems are incompatible, no cable facilitating such a direct connection exits, or any other such reason, and without the need to resort to wireless data transfer between the remote devices.

In general, in some embodiments, portable storage device 200 can act to create a direct connection between the first 206 and the second 208 connector, between the first 206 and the third 207 or between the second 208 and the third 207 connectors. That is, in some embodiments, the portable storage device 200 can allow a user to transfer data from one device to the other, at least without permanently storing the data in the memory 202 of the portable storage device 200. For example, memory 202 can provide a buffer for data transfer between two portable devices connected to the portable storage device 200. In other embodiments, data must first be transferred from one remote device to the memory 202 of the portable storage device, and then to a second remote device from memory 202.

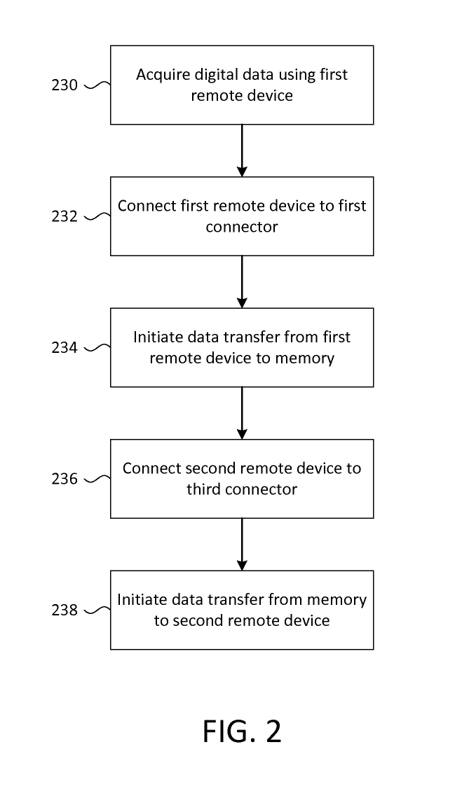

FIG. 2 is a process-flow diagram illustrating an exemplary method for utilizing a portable storage device as an intermediary between two remote devices. A user can acquire 230 digital data using a first remote device. Digital data can comprise, for example, photos, videos or audio data. Next, the user can connect 232 the first remote device to the first connector on the portable storage device. Once connected, the user can initiate 234 a transfer of the digital data from the first remote device to the memory of the portable storage device. The user can initiate 234 the data transfer via the first remote device, which acts as a host to the portable storage device. The user of a second remote device can connect 236 the second remote device to the third connector, and, if the desired digital data has been transferred to the memory of the portable storage device, initiate 238 transfer of the digital data from the memory of the portable storage device to the second remote device. In some configurations, the user of the second remote device can initiate 238 the transfer of the digital data via the second remote device, which can control operation of the portable storage device. As a result, digital data acquired at a first remote device, can be transferred to a second remote device utilizing a portable device without the need of wireless data transmission or the need for the two devices to be compatible.

In some exemplary processes, the user of the first remote device initiates 234 the transfer of digital data from the first remote device to the portable storage device and disconnects the first remote device from the first connector prior to the user of the second remote device connecting the second remote device to the portable storage device via the third connector. Alternatively, in some instances, the first remote device remains connected to the first connector while the digital data is transferred to the second remote device via the third connector.

As described, data transfer from the first remote device to the portable storage device can be initiated/controlled via the first remote device, and data transfer from the portable storage device to the second remote device can be initiated/controlled via the second remote device. However, in some configurations, the connections between the first and second remote devices and the portable storage device via the first and third connectors facilitate the complete control of data transfer by either the first or second remote device via either of connections 210 or 211 shown in FIG. 1. That is, in some examples, if first and second remote devices are simultaneously connected to first and third connectors, respectively, a user of either the first or second remote device can initiate data transfer between the portable storage device and either of the first and second remote devices.

In some embodiments, the portable storage device acts as a buffer during data transfer between first and second remote devices. In some configurations, a user can, for example, via the first remote device, select data from the second remote device to transfer to the first remote device. After initiating the transfer, in some embodiments, the selected data will be transferred from the second remote device and stored only temporarily in the memory 202 of the portable storage device. The data from the memory 202 of the portable storage device will then be transferred to the first remote device and removed from memory 202 of the portable storage device. With regard to FIG. 2, transferring data from the first remote device to the second remote device via a buffer effectively eliminates the active step of initiating 234 data transfer from the first remote device to memory. Instead, the entire transfer process from the first remote device to the second remote device is initiated at the second remote device. In general, processes outlined in FIG. 2 can be performed with various steps permuted, omitted, or performed simultaneously, depending on the preference or intention of the user and the embodiment of the portable storage device.

During an exemplary use, a user operates a first remote device, such as a smartphone, for acquiring digital data. Data can comprise, for example, music, video, or image data captured by the user using the first remote device. With use, the memory of the first remote device becomes full. In some instances, the user wishes to transfer acquired digital data to a second remote device. The user can connect the first remote device to the portable storage device 200 via the first connector 206 and move digital data from the internal memory of the first remote device to the memory 202 of the portable storage device 200 via connection 220 in order to clear space for acquiring more digital data.

A second remote device can be connected to the portable storage device 200 via the third connector 207. A user can transfer the data acquired on the first remote device from the memory 202 in the portable storage device 200 to the second remote device. As discussed, in various embodiments, this transfer of data can be initiated via the first and/or the second remote device coupled to the portable storage device 200.

Thus, the user can use the portable storage device 200 as an intermediary for transferring acquired digital data between a first and a second remote device. A user can also transfer data stored on the portable storage device 200 to either of the remote device, or stream data from the portable storage device for use with the first and/or second remote device. For example, a user can connect a smartphone to the portable storage device and play a video file on the smartphone that is located on memory 202 in portable storage device.

Through use, the memory 202 in the portable storage device becomes full. In some embodiments, the portable storage device comprises a second connector 208 for connecting to an external device. In some embodiments, the second connector 208 comprises a male USB connector, and the external device comprises a computer. In addition, the user can initiate two-way data transfer between the portable storage device and the external device, enabling the clearing of memory 202 to provide available storage in the portable storage device. In some embodiments, the interface between the portable storage device and the external device adopts a similar host/device relationship as described above, in which data transfer is controlled via the external device.

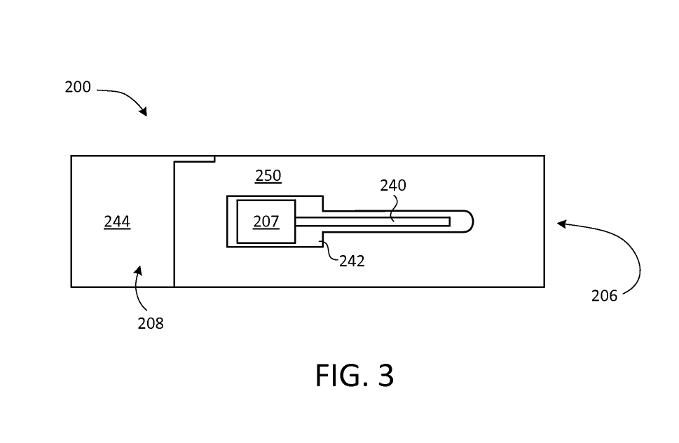

FIG. 3 is a view of an exemplary portable storage device according to some embodiments of the invention. In the illustrative embodiment of FIG. 3, the portable storage device 200 includes a first connector 206 disposed in one end of a longitudinal housing 250 and a second connector 208 disposed in the end opposite the first connector 206. In the embodiment of FIG. 3, the portable storage device 200 includes a cap 244 disposed over the second connector 208 for protecting the connector, for example. The portable storage device 200 includes a third connector 207 connected to the side of the housing 250. In the illustrated embodiment, third connector 207 is connected to the housing 250 via cable 240 for conveniently connecting the third connector 207 to a remote device. When not connected to a device, third connector 207 and cable 240 can be secured in groove 242 in the housing 250 so as to not hang free from the housing 250. In some embodiments, cable 240 can be integrally coupled to the housing 250 of the portable storage device 200, while in other embodiments, cable 240 can be detachable therefrom.

While the embodiment of FIG. 3 shows first 206 and second 208 connectors being disposed in the housing 250 of the portable storage device 200 and third connector 207 attached via cable 240, it will be appreciated that any of first, second and third connectors as described herein can be integrated into the housing 250 of the portable storage device 200 or attached thereto via an attachment such as cable 240. Moreover, first 206, second 208 or third 207 connectors can be all the same type of connector, different types of connectors, or any combination thereof. Any connectors can further be either male or female according to various embodiments of the invention. In general, first connector 206 is configured to conform to a first connector standard, second connector 208 is configured to conform to a second connector standard, and third connector 207 is configured to conform to a third connector standard. First, second and third connector standards can be dependent on the devices with which first 206, second 208 and third 207 connectors are intended to interface.

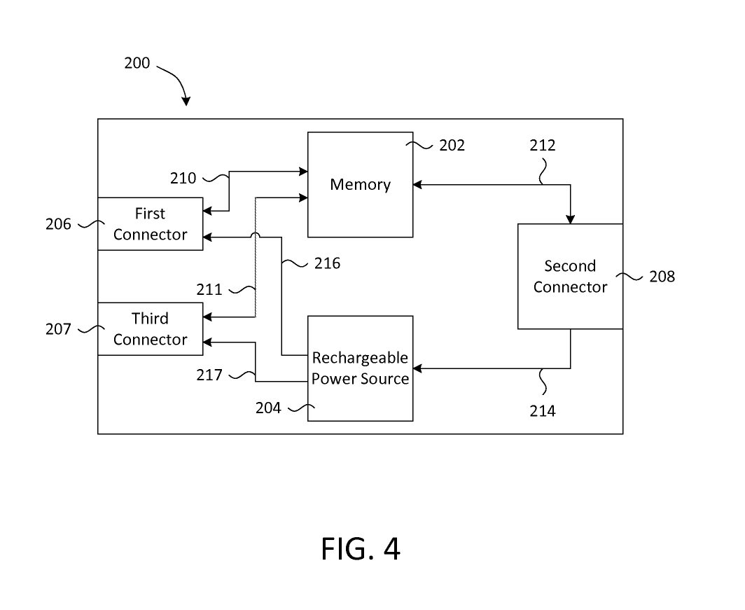

In some embodiments, portable storage device 200 can include a rechargeable power source 204 such as that shown in FIG. 4. FIG. 4 is a schematic diagram of a portable storage device including a rechargeable power source. As shown, first connector 206 can coupled to the rechargeable power source 204. Rechargeable power source 204 can include known rechargeable elements including lithium ion, lithium polymer, nickel metal hydride, capacitive or other known rechargeable power storage technology. During use, when a user connects a first remote device to the first connector 206 of the portable storage device 200, the rechargeable power source 204 of the portable storage device 200 can provide electrical power to the first remote device via the first connector 206. Rechargeable power source 204 can provide power to the first remote device via a one-way connection 216. This power can be used to charge the battery of the first remote device. Similarly, the third connector 207 can be coupled to the rechargeable power source 204 via connection 217 such that the rechargeable power source can provide electrical power to a second remote device connected to the portable storage device 200 via the third connector 207.

In various embodiments, the capacity of the rechargeable power source 204 can range between about 1000 and 5000 mAh. In some embodiments, the capacity of the rechargeable power source 204 is specific to a particular remote device, having the same or similar capacity as the first or second remote device. In some embodiments, the user can control whether or not the remote device is charged by the portable storage device 200. In further embodiments when a first remote device and a second remote device are connected to the first 206 and third 207 connectors, respectively, a user of the first and/or second remote device can control which of the remote devices is charged by the portable storage device 200. In other embodiments, charging of the first and/or second remote device occurs automatically when connected via the first 206 or third 207 connector. In some examples, portable storage device 200 is configured with a charging hierarchy, wherein, for example, if a first remote device is connected via the first connector 206, it will be charged by the portable storage device 200 regardless of the presence of a second remote device; however, a second remote device connected via the third connector 207 may receive electrical power only if no first remote device is connected via the first connector 206.

In some configurations, when the second connector 208 is connected to an external device, the external device can provide electrical power to the rechargeable power source 204 via connection 214. Thus, when the rechargeable power source 204 becomes depleted of charge, it can be recharged via the external device and the second connector 208, and can subsequently be used to charge a remote device via first 206 or third 207 connectors, for example. In some embodiments, charge can be transferred to or from the rechargeable power source 204 while data is being transferred to or from memory 202. Accordingly, a user can simultaneously charge a remote device and transmit digital data to or from the remote device via the first 206 or third 207 connector. Similarly, a user can simultaneously charge the rechargeable power source 204 and transfer digital data to or from an external device via the second connector 208. In some further embodiments, the portable storage device 200 can include a connector for connecting to a power receptacle such as a plug for a wall socket for charging the rechargeable power source. Such a connector can be embedded into a sidewall of the portable storage device or can be attached thereto via a cable, for example. Such an embodiment provides an alternative connection via which a user can charge the rechargeable power source 204 within the portable storage device 200 if, for example, a standard power outlet is available and the user is without his or her charging cable.

Various examples have been described. In some embodiments, the portable storage device can include any number of connectors for connecting to various remote devices. A user of any connected remote device can control data flow between the memory in the portable storage device and any attached remote device in a host/device configuration. In some cases, the portable storage device can act as an intermediary between a plurality of simultaneously connected remote devices, allowing data to be transferred therebetween. In some embodiments, the portable storage device can include a rechargeable power source for providing charge to a remote device, while other embodiments do not include such a component. Embodiments described herein are exemplary in nature and do not limit the scope of the invention.

1. A portable storage device comprising:
memory;
a first connector connectable to a first remote device and capable of providing two-way data transfer between the memory of the portable storage device and the first remote device;
a second connector connectable to an external device and capable of providing two-way data transfer between the memory of the portable storage device and an external device; and
a third connector connectable to a second remote device and capable of providing two-way data transfer between the memory of the portable storage device and the second remote device.

2. The portable storage device of claim 1, further comprising a rechargeable power source; and wherein the first connector is capable of providing electrical power from rechargeable power source to the first remote device simultaneously with two-way data transfer; and
the third connector is capable of providing electrical power from the rechargeable power source to the second remote device simultaneously with two-way data transfer.

3. The portable storage device of claim 1, wherein the first connector and third connector are each one of: a USB, micro-USB, mini-USB, HDMI, MHL, Lightning, 30-pin, and serial connector.

4. The portable storage device of claim 3, wherein third connector is different from first connector.

5. The portable storage device of claim 1, where the second connector is a male USB connector.

6. The portable storage device of claim 1, wherein the memory comprises removable memory.

7. The portable storage device of claim 6, wherein size of the memory is selectable by a user.

8. The portable storage device of claim 1, wherein the memory size is one of: 16, 32, 64, 128, 256 or 512 GB, or 1 TB.

9. The portable storage device of claim 1, wherein the first and second remote devices comprise one of a tablet and a smartphone.

10. The portable storage device of claim 9, wherein the first and second remote device comprise software for facilitating the two-way data transfer.

11. The portable storage device of claim 10, wherein the software comprises an application installed by the user.

12. The portable storage device of claim 1, wherein the external device is a computer.

13. The portable storage device of claim 1, wherein at least one of the first and third connectors comprises a cable secured to the body of the portable storage device and a male connector disposed at the end of the cable; and the second connector is integrated into the body of the portable storage device .

14. A method for transferring data between two remote devices comprising:
providing a portable storage device comprising a memory, a first connector for interfacing with a first remote device, a second connector for connecting to an external device, and a third connector for interfacing with a second remote device;
coupling the first connector of the portable storage device to the first remote device;
initiating the transfer of data from the first remote device to the memory of the portable storage device via the first connector;
coupling the third connector of the portable storage device to the second remote device;
and
initiating the transfer of data from the memory of the portable storage device to the second remote device via the second connector.

15. The method of claim 14, wherein initiating the transfer of data from the first remote device to the memory of the portable storage device via the first connector and initiating the transfer of data from the memory for the portable storage device to the second remote device via the second controller are each performed using exclusively one of the first and second remote devices.
